(19) United States
(12) Patent Application Publication
(10) Pub. No.: US 2022/0377159 A1
(43) Pub. Date: Nov. 24, 2022

(54) Method for Transmitting Subscription Data, and Also Data Provision Component, Data Consumption Component, Network and Installation

(71) Applicant: Siemens Aktiengesellschaft, München (DE)

(72) Inventors: Johannes Rohwer, München (DE); Hubertus Hohl, Staufen (DE); Markus Sauer, München (DE)

(73) Assignee: Siemens Aktiengesellschaft, München (DE)

(21) Appl. No.: 17/775,977

(22) PCT Filed: Nov. 11, 2020
(86) PCT No.: PCT/EP2020/081697

§ 371 Date: May 11, 2022

(30) Foreign Application Priority Data
Nov. 12, 2019 (DE) 10 2019 217 463.9

(51) Int. Cl. H04L 69/24; H04L 67/55

(52) U.S. Cl. CPC H04L 69/24; H04L 67/55

(57) ABSTRACT

Various embodiments include a method for transmitting subscription data in a brokerless publication/subscription service from a data provision component to a data consumption component. The method includes: reaching agreement between the data consumption component and the data provision component upon a protocol; and transmitting the subscription data from the data provision component to the data consumption component in the protocol agreed upon.

### CROSS-REFERENCE TO RELATED APPLICATIONS

This application is a U.S. National Stage Application of International Application No. PCT/EP2020/081697 filed Nov. 11, 2020, which designates the United States of America, and claims priority to DE Application No. 10 2019 217 463.9 filed Nov. 12, 2019, the contents of which are hereby incorporated by reference in their entirety.

### TECHNICAL FIELD

The present disclosure relates to data management. Various embodiments of the teachings herein include methods for transmitting subscription data in a brokerless publication/subscription service from a provision component to a data consumption component, data provision components, data consumption components, networks, and installations.

### BACKGROUND

In industrial automation, for instance in the field of the industrial Internet of Things, brokerless publication/subscription services, also known as brokerless publish/subscribe services, are used. Such publication/subscription services predefine a uniform protocol for data transmission in order that all linked functional components can communicate with one another despite their possibly high degree of heterogeneity. Such functional components are, for instance, data provision components that provide subscription data, and also data consumption components that obtain said subscription data.

However, precisely because of a possible high degree of heterogeneity of the functional components, the individual functional components are not necessarily optimized to said uniform protocol, thus resulting in a reduced performance and a high configuration outlay of such a publication/subscription service. Furthermore, a dynamic adaptation to new applications during ongoing operation of such a publication/subscription service regularly proves to be difficult.

### SUMMARY

The teachings of the present disclosure may provide an improved method for transmitting subscription data in a brokerless publication/subscription service in the form of process data of a manufacturing and/or work method from a data provision component to a data consumption component. Some embodiments include a method by which the publication/subscription service can be adapted to new applications with little outlay and which allows the performance of data consumption components and/or data provision components to be significantly increased. Furthermore, the teachings herein may provide data provision components and data consumption components by means of which the methods can be carried out as well as networks of such data consumption components and data provision components and installations comprising such a network.

For example, some embodiments include a method for transmitting subscription data (DAT) in a brokerless publication/subscription service, e.g. in the form of process data in particular of a manufacturing and/or work method, from at least one data provision component (DP) to at least one data consumption component (DC), wherein the at least one data consumption component (DC) and the at least one data provision component (DP) agree upon at least one protocol and wherein the data provision component (DP) transmits the subscription data (DAT) in at least one of the protocols agreed upon.

In some embodiments, the data consumption component (DC) communicates at least one protocol identifier (PKE) assignable to the subscription data (DAT), and identifying at least one protocol processable by the data consumption component (DC), to the at least one data provision component (DP).

In some embodiments, the at least one data provision component (DP) communicates at least one protocol identifier (PKE) assignable to the subscription data, and identifying at least one protocol providable by the data provision component (DP), to the at least one data consumption component (DC).

In some embodiments, the at least one data consumption component (DC) embeds the protocol identifier (PKE) into a subscription-establishing communication (MCMCN) between data provision component (DP) and data consumption component (DC).

In some embodiments, the protocol agreed upon forms a protocol processable by the data provision component (DP) and/or a protocol processable by the data consumption component (DC).

In some embodiments, the at least one data provision component (DP) is a field device (20), in particular having at least one sensor for at least one process parameter of a manufacturing method and/or work method, and/or a data consumption component (DC).

In some embodiments, the field device (20) is arranged and configured for detecting a physical variable of a machine, e.g. an industrial robot and/or motor.

In some embodiments, the at least one identified protocol comprises a or the Internet protocol and/or a or the user datagram protocol and/or a or the real time transport protocol and/or one or more specialized network protocol(s), in particular Profibus and/or OPC UA and/or BACnet and/or Modbus and/or ZigBee.

As another example, some embodiments include a data provision component, designed for participating in a method as described herein, and configured to receive at least one protocol identifier (PKE) from the data consumption component (DC) and to transmit subscription data (DAT) in a protocol identified by the protocol identifier (PKE) and/or to transmit at least one protocol identifier (PKE) to the data consumption component (DC).

As another example, some embodiments include a data consumption component, designed for participating in a method as described herein, and configured to communicate at least one protocol identifier (PKE) to the data provision component (DP) and/or to receive at least one protocol identifier (PKE) from the data provision component (DP).

As another example, some embodiments include a network comprising at least one or a plurality of data provision components (DP) as described herein and/or comprising at least one or a plurality of data consumption components (DC) as described herein, and designed for carrying out a method as described herein.

As another example, some embodiments include an installation, in particular comprising at least one or a plurality of machines (IM, IR), comprising a network (10) as described herein.

### BRIEF DESCRIPTION OF THE DRAWINGS

The teachings of the present disclosure are explained in greater detail below on the basis of exemplary embodiments illustrated in the drawing, in which:

FIG. 1 schematically shows a local network of data provision components and data consumption components of a brokerless publication/subscription service incorporating teachings of the present disclosure in a basic schematic diagram; and

FIG. 2 shows a diagrammatic illustration of a transmission of process data from a data provision component to a data consumption component of the network in accordance with FIG. 1 schematically in a basic schematic diagram.

### DETAILED DESCRIPTION

The methods described in the present disclosure for transmitting subscription data in a brokerless publication/subscription service from at least one data provision component to at least one data consumption component serve for transmitting subscription data. In some embodiments, the subscription data are process data in particular of a manufacturing and/or work method. In some embodiments, the at least one data consumption component and the at least one data provision component agree upon at least one protocol and the data provision component transmits the subscription data in at least one of the protocols agreed upon.

In the context of this disclosure, the term subscription data means process data. A work method within the meaning of this disclosure means a method which acts on at least one material and/or at least one object, without altering said at least one material and/or said at least one object as such (see the German Federal Supreme Court decisions “Handhabungsgerät” [“Handling device”] and “Arzneimittelgebrauchsmuster” [“Utility model for pharmaceuticals”]), in particular an open-loop and/or closed-loop control method and/or a measuring method. A work method means a work method as defined in Schulte “Patentgesetz mit EPÜ” [“German Patents Act with EPC”], 9^{th} edition, § 1, marginal number 239, first sentence.

The expression according to which data consumption component and data provision component “agree upon at least one protocol” means that the protocol is actually defined only after an information exchange of data provision component and data consumption component. A previously defined protocol for the data provision component and the data consumption component for transmitting the subscription data is intended precisely not to be encompassed by this expression. In other words, there is always a non-vanishing agreement latitude beforehand on the part of data provision component and data consumption component.

A data provision component within the meaning of this disclosure denotes a data publication component of the publication/subscription service. Expediently, the data provision component is a component of the brokerless publication/subscription service that publishes, i.e. provides, the subscription data. The terms data provision component and data publication component can be used synonymously. Brokerless publication/subscription services are also referred to as brokerless publish/subscribe services.

In some embodiments, it is possible to take account of different requirements in respect of the transmission of the subscription data of individual subscriptions and thus to optimize the chosen protocol for the respective subscription. In particular, the protocol can be suitably chosen and preferably optimized with regard to a latency, i.e. a signal publication time, and also with regard to a data throughput of the subscription data and a bandwidth available for the transmission of the subscription data and/or a reliability and/or security and/or a so-called Quality of Service (QoS).

Thus, for instance, subscription data which are formed with measurement values which are generated at time intervals of, in particular less than 10, milliseconds and in which the loss of individual measurement values is acceptable can be transmitted with low latency in an expedient manner by means of UDP. By contrast, subscription data containing, in comparison therewith, low-frequency telemetry data to be protected against loss can be transmitted in particular by means of a TCP protocol (TCP=“Transmission Control Protocol”) with higher latency, but with a comparatively high Quality of Service (QoS), such that packet losses are able to be completely compensated for. Subscription data which are to be communicated for instance during a continuous transmission of in particular audiovisual data can be transmitted in particular by means of a real time transport protocol (RTP) in the method according to the invention.

In some embodiments, not just static data but rather—in particular additionally or alternatively—continuous subscription data such as, in particular, multimedia data streams comprising audio and/or video and/or text data can be transmitted in the method according to the invention. Expediently, such subscription data may contain augmented reality data and/or virtual reality data and are particularly preferably transmitted in real time, i.e. with the lowest possible latency.

In some embodiments, the development and configuration outlay for incorporating field devices and/or edge devices in a brokerless publication/subscription service is significantly reduced in the methods described herein. The administration outlay of a publication/subscription service may be significantly reduced.

In some embodiments, subscription data of an individual subscription can thus be transmitted by way of a protocol which is negotiated by data consumption component and data provision component, is appropriate for data consumption component and data provision component and is tailored as far as possible to an envisaged purpose of use.

In some embodiments, in a brokerless publication/subscription service for transmitting subscription data, the fixedly predefined transmission method, i.e. the fixedly predefined protocol, is replaced by a protocol that is agreed upon flexibly, such that data provision components and data consumption components can in each case agree upon a protocol that is suitable for the respective purpose of transmitting the subscription data. In contrast to known publication/subscription services, the protocol can be dynamically defined in a suitable manner for each individual subscription in particular at the time of execution. Such a suitable protocol can be determined for instance with regard to the highest possible capacity utilization of data consumption component(s) and/or data provision component(s) and/or transmission capacity of a respective data transmission channel connecting a data provision component and a data consumption component. Furthermore, a suitable protocol can be chosen depending on the desired transmission rate and/or security and/or reliability of the transmission of the subscription data.

In some embodiments, the data consumption component communicates at least one protocol identifier assignable to the subscription data, and identifying at least one protocol processable by the data consumption component, to the at least one data provision component. In some embodiments, data consumption component and data provision component can agree upon the protocol in a simple manner by the respective data consumption component communicating the protocol identifier and the respective data provision component, if it can transmit subscription data in a protocol identified by the protocol identifier, transmitting the subscription data.

In some embodiments, the at least one data provision component communicates at least one protocol identifier assignable to the subscription data, and identifying at least one protocol processable by the data provision component, to the at least one data consumption component. In some embodiments, data consumption component and data provision component can agree upon the protocol in a simple manner. For this purpose, the respective data provision component communicates the protocol identifier, and the respective data provision component transmits the subscription data to the data consumption component if the data consumption component can receive subscription data in a protocol identified by the protocol identifier and it signals arising of a subscription to the data provision component.

In the present disclosure, a protocol processable by the data provision component means a protocol in which a data provision component can provide subscription data.

In some embodiments, the at least one data consumption component embeds the protocol identifier into a subscription-establishing communication between data provision component and data consumption component. In this way, the communication that is to be undertaken anyway for establishing a subscription can simultaneously be utilized for transmitting the protocol identifier. This communication is expediently extended by the protocol identifier. Accordingly, a protocol can be agreed upon without additional communication processes or additional data channels. Consequently, by means of the method according to the invention, an existing publication/subscription service is extendable by additional applications or protocols at the time of execution in a particularly simple manner since fundamental changes to the system architecture or the configuration are not necessary. A subscription-establishing communication is understood to mean a communication by means of which the subscription is agreed upon between data provision component and data consumption component.

In some embodiments, a plurality of protocols are identified by means of the protocol identifier. In this case, the protocols can be provided with a weighting by means of the protocol identifier, such that for instance in the case where both the data provision component and the data consumption component can process two or more protocols identified by the protocol identifier, a specific protocol from the set of identified protocols is preferably used. Such a preference can include for instance a preference for a connectionless and/or packet-oriented or a connection-oriented protocol.

In some embodiments, the at least one or the plurality of data consumption components and also the at least one or the plurality of data provision components are designed to be able to process at least one fallback or standard protocol, i.e. to be able to communicate subscription data and/or to be able to receive subscription data in said fallback or standard protocol.

In some embodiments, different data consumption components can offer different protocols for the same subscription, i.e. for the same subscription data, by means of a protocol identifier. Expediently, each data provision component independently decides which of the offered protocols it will use to communicate subscription data. Different data provision components can expediently select different protocols for otherwise identical subscriptions, that is to say for otherwise identical subscription data.

In some embodiments, the methods include optimizing a data format of the subscription data with regard to the protocol agreed upon: in particular, subscription data are transmitted in the form of raw data of an individual measurement variable and/or in the form of binary data blocks and/or complex data structures. In some embodiments, the protocol agreed upon forms a protocol processable by the data provision component and/or a protocol processable by the data consumption component.

In some embodiments, the at least one data provision component is a field device, in particular having at least one sensor for at least one process parameter of a manufacturing method and/or work method. Data which are expediently communicated as subscription data from field devices to data consumption components regularly arise precisely in industrial work methods and/or industrial manufacturing methods.

In some embodiments, the data provision component simultaneously forms a data consumption component, for instance a gateway component, which forms an edge device in the field of an industrial Internet of Things. In other words, a field device can form a data provision component in a first application and can form a data consumption component in a second application.

In some embodiments, the at least one field device is arranged and configured for detecting at least one physical variable of a machine, preferably of an industrial robot and/or motor. In advantageous developments of the invention, the at least one physical variable is a variable that occurs in an industrial work method and/or industrial manufacturing method.

In some embodiments, the at least one identified protocol comprises an Internet protocol and/or a user datagram protocol and/or a real time transport protocol and/or one or more specialized network protocol(s), in particular Profibus and/or OPC UA and/or BACnet and/or Modbus and/or ZigBee.

The abovementioned protocols are established in particular in industrial automation, in particular in the field of the industrial Internet of Things (Industrial IoT), and are routinely used during the transmission of data in the context of M2M communication (M2M=“Machine-to-Machine”). Advantageously, such protocols support a high-performance transmission of subscription data, in particular process data, in particular from field devices to edge devices. In some embodiments, field devices and edge devices can communicate by way of their respective specialized and industry-standard protocols. Recourse to a uniform protocol, predefined by the publication/subscription service, for transmitting subscription data such as process data, in particular, is not necessary. In some embodiments, the technically possible performance of individual data provision components and/or data consumption components of a publication/subscription service can be fully exploited.

In some embodiments, a publication/subscription service can easily be adapted to new applications even during ongoing operation, since a commitment to a uniform, predefined protocol for transmitting subscription data with previously determined advantages and disadvantages of the specific protocol is not required. In some embodiments, the methods therefore allow a publication/subscription service to be set up particularly flexibly, without complex reconfigurations being required.

In some embodiments, a method is expediently divided into two process steps. In this case, different protocols for transmitting data can be used for these two process steps: in a first process step, a subscription is set up, i.e. established. A broadcast and/or multicast message which can be understood in particular by all data provision components can be used in this case. Expediently, when setting up the subscription, a protocol for transmitting the subscription data is agreed upon at the same time. In a second step, the subscription data associated with the subscription are subsequently transmitted in the protocol agreed upon.

In some embodiments, the data provision component is designed for participating in a method as described above, and configured to receive at least one protocol identifier from the data consumption component and, by means of said protocol identifier, to ascertain whether the data provision component can transmit the subscription data in a protocol of the protocol identifier, and, if appropriate, to transmit the subscription data in one of the protocols identified by the protocol identifier. In some embodiments, the data provision component is designed to transmit at least one protocol identifier to the data consumption component. The data provision component can thus perform the role of a data provision component of the method as described above.

In some embodiments, the data provision component is configured for the subscription-establishing communication with at least one data consumption component. The data consumption component is designed to participate in a method as described above, and configured to communicate at least one protocol identifier to the data provision component or to receive at least one protocol identifier from the data provision component and, by means of said protocol identifier, to ascertain whether the data consumption component can receive subscription data in one of the protocols identified by the protocol identifier, and, if appropriate, to receive subscription data in a protocol identified by the protocol identifier.

In some embodiments, the data consumption component is configured for the subscription-establishing communication with at least one data provision component. The data consumption component can thus additionally perform the role of a data consumption component of the methods as described above.

In some embodiments, a network comprises at least one or a plurality of data provision components and also at least one or a plurality of data consumption components designed to participate in a method as described above. In some embodiments, an installation comprises one or a plurality of machines and also a network as described above, in some cases at least partly arranged at the one or the plurality of machines.

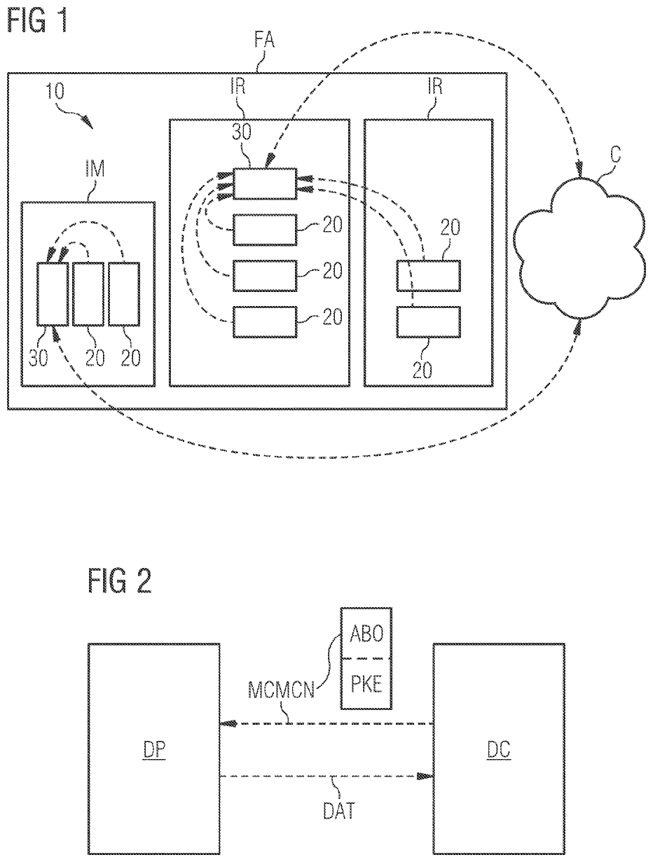

The local network 10 illustrated in FIG. 1 comprises a plurality of field devices 20 in an automated manufacturing installation FA. A local network 10 within the meaning of this invention denotes a network 10 which is spatially delimited to the manufacturing installation FA. The manufacturing installation FA comprises firstly stationary industrial motors IM and secondly industrial robots IR, which each implement steps of a manufacturing method realized by the manufacturing installation FA. In some embodiments, the industrial robots IR can additionally also carry out steps of a work method.

The field devices 20 comprise sensors which are arranged on the stationary industrial motors IM and comprise temperature sensors for detecting a temperature of the respective industrial motor IM on which they are arranged, and/or rotational speed measuring units for detecting a rotational speed of the respective industrial motor IM on which they are arranged. The field devices 20 additionally comprise state of charge sensors which are arranged on the industrial robots IR of the manufacturing installation FA and which are designed to detect a state of charge of an electrical energy store of the industrial robot IR.

In some embodiments, the field devices 20 can also comprise or be all the other sensors arranged on an installation or machine. The field devices 20 are signal-connected to edge devices 30 for communication purposes. Edge devices 30 within the meaning of the present invention denote gateways which mediate between field devices 20 and a nonlocal network C and, in order to avoid latencies and in order to conserve data transmission resources, independently process a portion of the data of the field devices and forward only a remaining portion of said data to the nonlocal network C.

In the exemplary embodiment illustrated, the edge devices 30 are arranged on the industrial motors IM and also on the industrial robots IR. In some embodiments, edge devices 30 can alternatively or additionally be arranged at other areas within the manufacturing installation FA, for example in a stationary fashion in a part of the manufacturing installation.

The nonlocal network C within the meaning of this disclosure is formed by a cloud network, for example. In some embodiments, the nonlocal network C can alternatively or additionally be formed by one or more servers. In principle, the nonlocal network C can be replaced by a completely or partly local further network. In some embodiments, edge devices 30 and only the edge devices 30 mediate between the local network 10 and the further network. In the exemplary embodiment illustrated, the field devices 20 thus constitute data provision components DP of the local network 10, while the edge devices 30 form data consumers DC of the local network 10. In the exemplary embodiment shown, the local network 10 optionally forms an industrial Internet of Things.

In this case, the local network 10 forms in particular a non-hierarchical and self-configuring network in which there is no predetermined assignment of a field device 20 to an edge device 30, rather a field device 20 can be added to the local network 10 and field device 20 and edge device 30 independently establish a signal connection, e.g. a wireless connection and/or Internet connection, to one another.

The signal connection between field device 20 and edge device 30 is effected data-specifically, that is to say that, with regard to different technical data to be transmitted, different assignments of field device 20 and edge device 30 can be established and exist in parallel with one another, in principle. For example, it is conceivable for a field device 20 to have both a rotational speed measuring unit and a temperature sensor, wherein data of the rotational speed measuring unit are to be transmitted to a first edge device 30 and temperature data are to be transmitted to a second edge device 30.

A data-specific transmission is effected by means of a brokerless publication/subscription service. In this service, edge devices 30 as data consumption components DC set up subscriptions of specific subscription data DAT from the field devices 20 functioning as data provision components DP, for example subscriptions of rotational speed data. This is effected by means of the methods described herein for transmitting subscription data DAT: in the method, the data consumption components DC announce their subscriptions to all the data provision components DP by means of broadcast and/or multicast messages MCMCN. The broadcast and/or multicast messages MCMCN are communicated from the data consumption components DC to the data consumption components DP by means of a uniform protocol, predefined by the publication/subscription service.

The broadcast and/or multicast messages MCMCN firstly contain, in a manner known per se, the respective subscription information ABO specifying the data to be transmitted, here rotational speed data, for example. The broadcast and/or multicast messages MCMCN additionally contain a protocol identifier PKE identifying the protocols processable by the data consumption component DC, i.e. receivable by the latter, for the transmission of the subscription data DAT. In this case, the protocol identifier PKE identifies at least one protocol.

In the exemplary embodiment illustrated, the protocol identifier PKE identifies in each case at least two protocols by means of which the data consumption component can receive the subscription data DAT. In the exemplary embodiment illustrated, such protocols can be connectionless protocols, which have a low latency, but do not necessarily require a complete data transmission, for instance a real time transport protocol (RTP), and/or connection-oriented protocols, in which a complete data transmission is ensured. By way of example, one or more of the at least two protocols is/are a Profibus and/or OPC-UA and/or BACnet and/or Modbus and/or ZigBee protocol.

In the exemplary embodiment illustrated, the protocol identifier PKE furthermore contains an optional weighting containing a preference of a protocol identified by the protocol identifier, for instance with regard to a connection-oriented or connectionless protocol or for example with regard to one or a plurality of preferred specific protocols.

By way of example, in the exemplary embodiment illustrated, for the transmission of subscription data DAT in the form of state of charge data of the industrial robots IR, a connectionless and packet-oriented protocol is preferred since the state of charge data in the present case are intended to be acquired as completely as possible over time in order to be able to predict as precisely as possible an operating period of an energy store of the industrial robots IR and thus a required charging of the energy store and accordingly to be able to plan in advance an adaptation of the manufacturing process of the manufacturing installation FA that is as frictionless as possible.

By way of example, with regard to subscription data DAT in the form of rotational speed data and the temperature data of an industrial motor IM, a connection-oriented protocol with real time capability may be used since a temporally synchronous monitoring of the rotational speed of the industrial motor IM and also of the temperature of the industrial motor IM can indicate possible anomalies of the operation of the industrial motor IM. Consequently, a connection-oriented protocol makes it possible, as necessary, promptly to be able to effect required adaptations of the operation of the industrial motor IM and, if appropriate, to avoid failure of the industrial motor IM. In some embodiments, other weightings can also influence the protocol identifiers PKE.

The data provision component DP then selects one of the protocols identified in the protocol identifier PKE, which protocol is available for the data provision component DP, for the transmission of the subscription data DAT. That protocol is selected which is available for the data provision component DP and which has the highest weighting for the given subscription. In the exemplary embodiment illustrated, the connection information additionally required for the transmission of the subscription data DAT, for example IP address and port, are contained in the protocol identifier PKE. In some embodiments, said connection information can however also be contained in the subscription information ABO.

FIG. 2 illustrates just a single pair of one data consumption component DC and one data provision component DP. In some embodiments, a plurality of data consumption components DC can identify different protocols with their protocol identifier PKE for the same subscription data DAT. In addition, a plurality of data provision components DP can select different protocols from the protocols identified by the protocol identifier PKE for the transmission of the subscription data DAT. In the exemplary embodiment illustrated, the local network 10 incorporates teachings of the present disclosure.

In the exemplary embodiment shown in the drawing, the data consumption components DC and also the data provision components DP respectively form data consumption components DC and also data provision components DP. Furthermore, the manufacturing installation FA described above and illustrated in the drawing constitutes an installation. In some embodiments, instead of a manufacturing installation FA, just an individual machine, for instance a single industrial robot IR, can be present, at which the local network comprises one or a plurality of edge devices 30 and also a plurality of field devices 20 at said single industrial robot IR.

In the exemplary embodiment illustrated, no subscription data DAT are transmitted by the data provision components DP if the data consumption components DC do not identify protocols which the data provision components DP can use for transmission. In some embodiments, a fallback or standard protocol is additionally provided, which is supported by all functional components of the local network, i.e. all edge devices 30 and also all field devices 20. Thus, if no protocol can be agreed between data provision component DP and data consumption component DC from the protocol identifier PKE, then instead the fallback or standard protocol is selected for communication purposes. In exemplary embodiments which do not provide a fallback or standard protocol, in the case where specific pairings of edge device 30 and field device 20 do not support a common protocol, subscription data DAT cannot be transmitted from the field device 20 to the edge device 30.

In some embodiments, field devices 20 and edge devices 30 are not necessarily strictly separate functional components of the subscription/subscription service, rather an edge device 30 performs the function of an edge device 30 with regard to one specific subscription, whereas it performs the function of a field device 20 for other subscriptions.

What is claimed is:

1. A method for transmitting subscription data in a brokerless publication/subscription service from a data provision component to a data consumption component, the method comprising:
reaching agreement between the data consumption component and the data provision component upon a protocol; and
transmitting the subscription data from the data provision component to the data consumption component in the protocol agreed upon.

2. The method as claimed in claim 1, further comprising:
communicating a protocol identifier assignable to the subscription data from the data provision component to the data consumption component; and
identifying a protocol processable by the data consumption component by the data provision component.

3. The method as claimed in claim 1, further comprising:
communicating with the data provision component a protocol identifier assignable to the subscription data; and
identifying a protocol providable by the data provision component to the at least one data consumption component.

4. The method as claimed in claim 1, further comprising using the data consumption component to embed the protocol identifier into a subscription-establishing communication (MCMCN) between data provision component and data consumption component.

5. The method as claimed in claim 1, further comprising forming a protocol processable by the data provision component and/or a protocol processable by the data consumption component.

6. The method as claimed in claim 1, wherein the data provision component comprises a field device having a sensor for a process parameter of a manufacturing method and/or work method, and/or a data consumption component.

7. The method as claimed in claim 6, wherein the field device is configured for detecting a physical variable of a machine.

8. The method as claimed in claim 1, wherein the identified protocol comprises an Internet protocol and/or a user datagram protocol and/or a real time transport protocol and/or a specialized network protocol.

9. A data provision component configured to:
receive a protocol identifier from a data consumption component; and
transmit subscription data in a protocol identified by the protocol identifier and/or transmit a protocol identifier to the data consumption component.

10. A data consumption component configured to:
communicate a protocol identifier to the data provision component; and/or
receive a protocol identifier from the data provision component.

11. A network comprising:
a plurality of data provision components configured to:
receive a protocol identifier from a data consumption component; and
transit subscription data in a protocol identified by the protocol identifier and/or transmit a protocol identifier to the data consumption component;
a plurality of data consumption components configured to:
communicate a protocol identifier to the data provision component; and/or
receive a protocol identifier from the data provision component;
wherein the data consumption component reaches agreement with the data provision component upon a protocol; and
the data provision component transmits subscription data to the data consumption component in the protocol agreed upon.

12. (canceled)
